(19) United States
(12) Patent Application Publication
(10) Pub. No.: US 2006/0075638 A1
(43) Pub. Date: Apr. 13, 2006

(54) (Dual purpose) wine bottle wax seal removal tool and bottle opener and optional (single purpose) wax seal remover

(76) Inventor: David Gregory Nunez, Seal Beach, CA (US)

Correspondence Address: David Gregory Nunez, 4401 Ironwood Avenue, Seal Beach, CA, 90740, US

(21) Appl. No.: 10/876,351

(22) Filed: Oct. 13, 2004

(51) Int. Cl. B67B 7/00

(52) U.S. Cl. 30/1.5

(57) ABSTRACT

The dual purpose wine bottle wax removal tool is a linear hand held metallic or other sturdy material whereby one end of the tool is a slightly bent, angular shaped tip for the purpose of insertion and removal of wax sealing material atop of many wine bottles. Additionally, the opposite end of the tool is comprised of one of many possible arrangements, compositions or construction for the purpose of prying off crimped bottle caps. Alternatively, the Single purpose version shall differ from the dual purpose version only by being devoid of a bottle opener and will necessarily have a larger handle comprised but not limited to rubber, plastic, metal or wood.

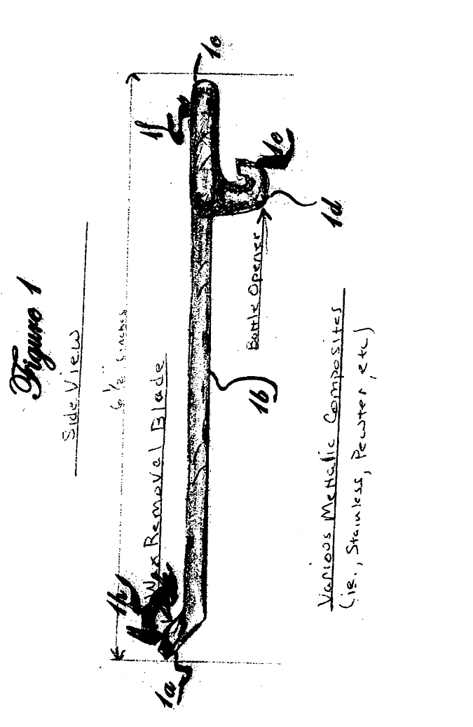

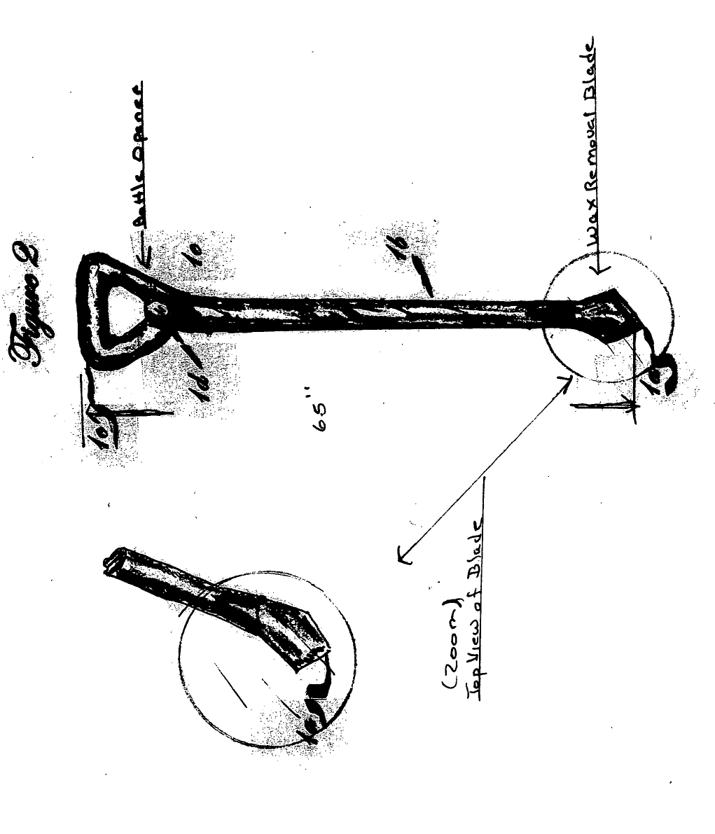

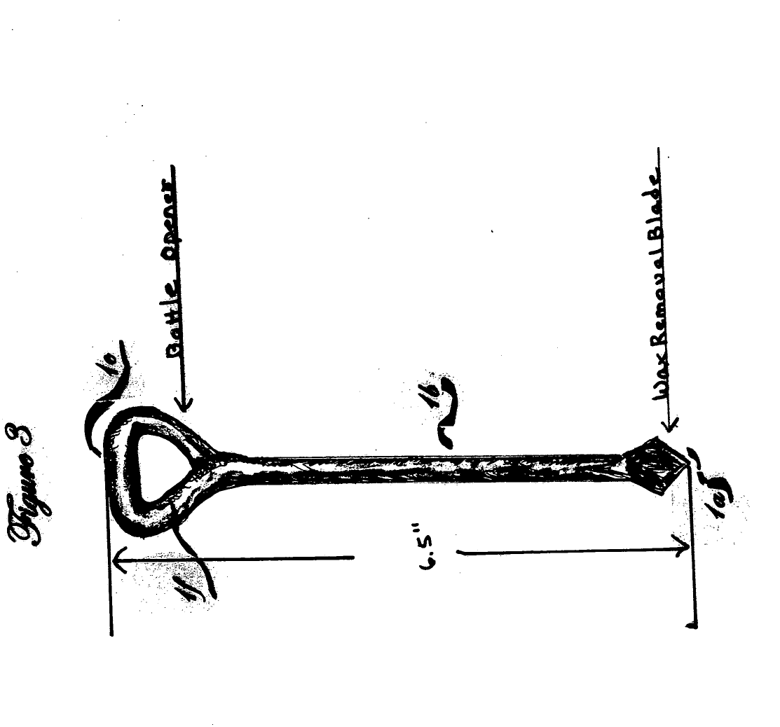

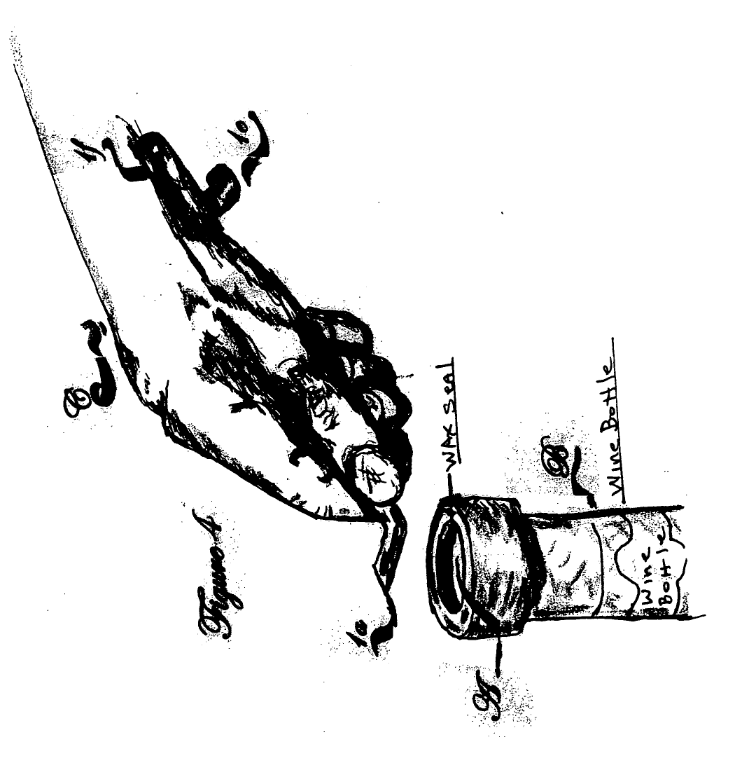

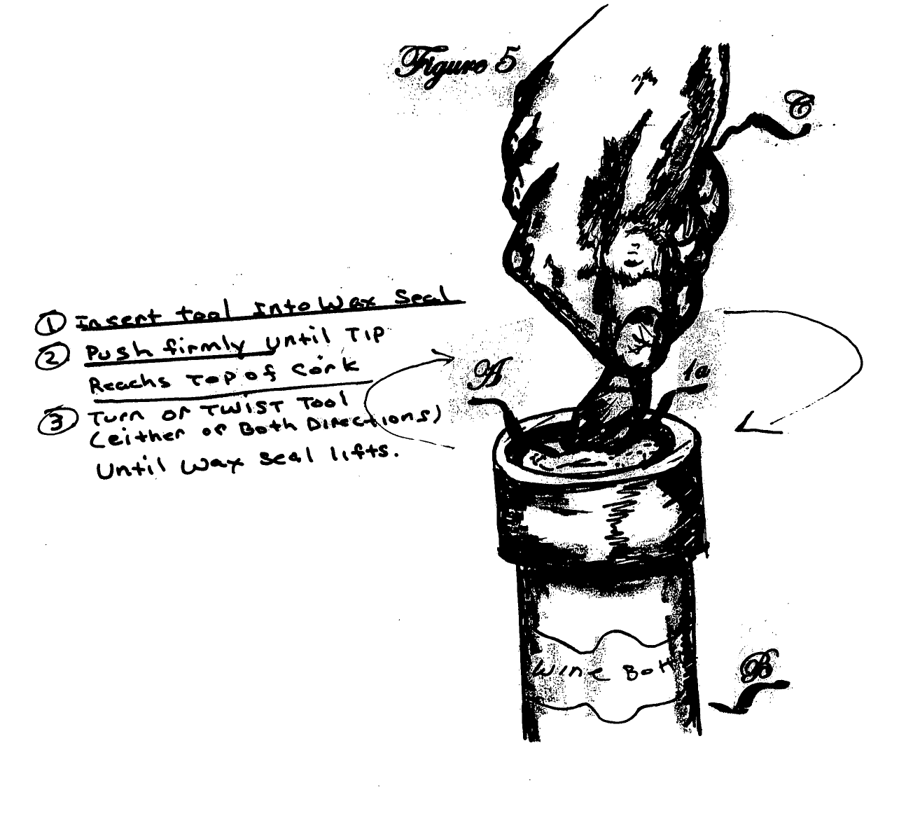

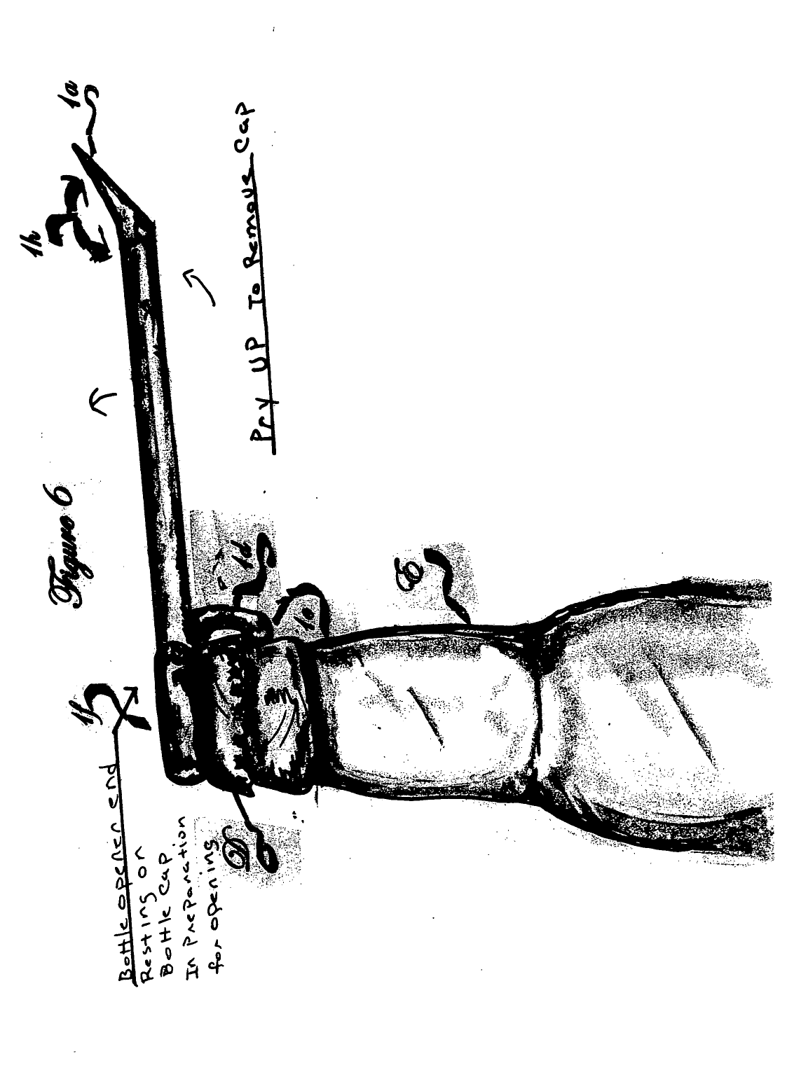

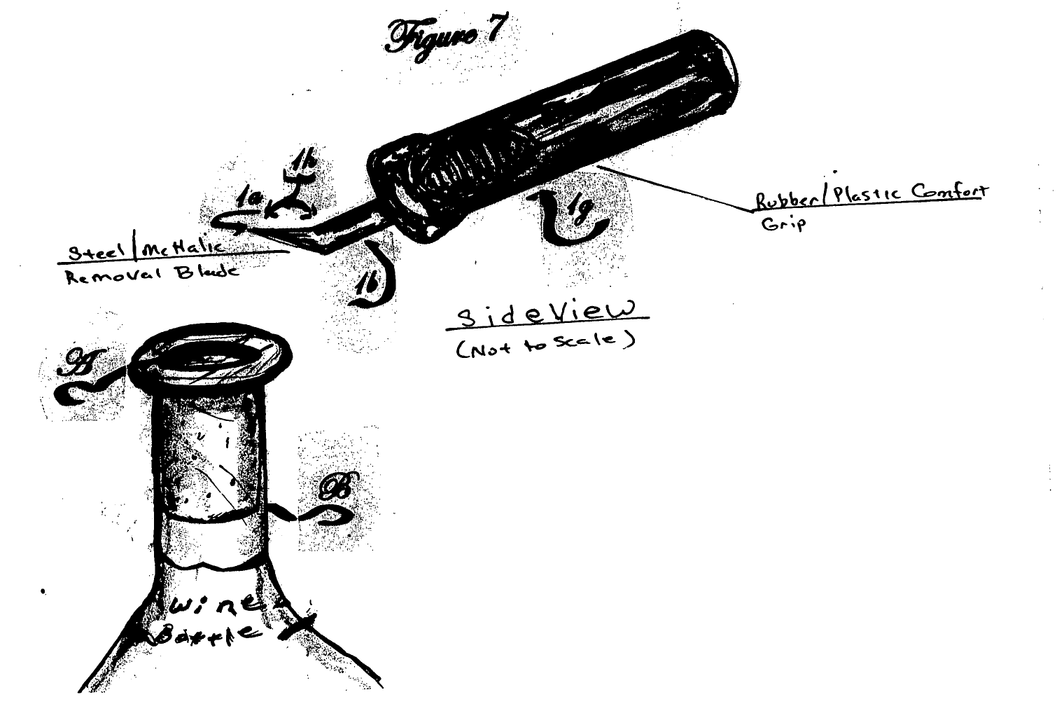

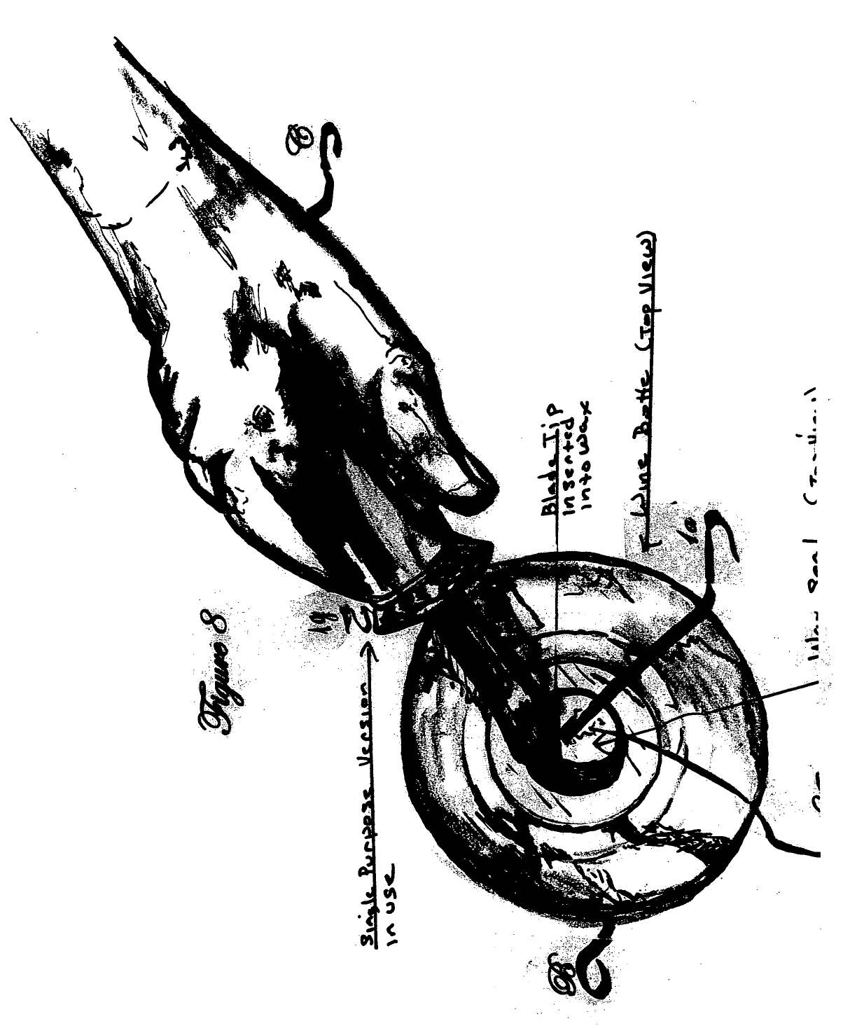

### CROSS REFERENCE TO RELATE APPLICATIONS

Provisional Application No. 60/455389: filing Date Mar. 13, 2003; Copy of Provisional application (attached)

### STATEMENT REGARDING FED SPONSORED R & D

N/A

### REFERENCE TO SEQUENCE LISTING, A TABLE, OR A COMPUTER PROGRAM LISTING APPENDIX

N/A

### BACKGROUND OF INVENTION

The (Dual Purpose) Wine Bottle Wax Removal Tool and Optional Version (Single Purpose) Wine Bottle Wax Seal Removal Tool offers both the user of high end cork removal devices and the manufacturers a method of easily removing the bee's wax seal from wine bottles as well as an additional, attached, bottle opener on the opposite end of the removal blade. The tool offers a remedial prevention to wax related damage to high-end corkscrews as well as a method to prevent bottle chipping and wax remnants from falling into wine glass during pouring process.

As virtually all domestically produced wine bottles have jettisoned the lead bottleneck seal many wine producers have begun to use “bee's wax” as a method of sealing the upper cork and bottle from (seepage of air and wine).

While the wax performs a good alternative function as a replacement of the lead neck sealer it poses other problems for the manufacturers of “high end” cork removal devices. If the wax is not removed, after extended use, it will begin to gum up the device and thereby damage the unit causing it not to function properly. In fact, some manufacturers specifically warn the wax may damage their unit and thereby void the warranty. As it stands today there is no tool specifically designed to remove this wax. Many attempt to pry the wax with the blade of a knife but the knife has the tendency to chip the edge of the bottle. This device (invention) has a strong angled (approximately 30 Degrees) steel blade that when inserted will not chip the bottle due to the angle of the blade tip. The blade imbedded into the wax and turned (side to side) easily removes the wax. As some of these units (corkscrews) cost as much as $100 or more and warranty replacement due to improper use may become a point of contention between consumer and manufacturer. Besides, many other consumers may simply be unaware of the damaging potential of the wax “build-up” simply because they have failed to read the manufacturers warnings or instructions.

The opposite end of the “. . . wax removal tool” is a simple bottle opener. Thereby giving the tool a dual functionality for both consumer, manufacturers of corkscrews, wine shops, bars and restaurants i.e. value added.

The optional Single Purpose version of the Wax removal tool mentioned above performs and functions identically to the Dual Purpose version with the exception of the bottle opener on the opposite end of the tool. The Single purpose option replaces the bottle opener with a simple grip or handle in order for the tool to comfortably remove only the wax as opposed to removing bottle caps.

### SUMMARY OF THE INVENTION “(DUAL PURPOSE) WINE BOTTLE WAX REMOVAL TOOL AND OPTIONAL (SINGLE PURPOSE) WINE BOTTLE WAX SEAL REMOVAL TOOL

The (dual purpose) Wine Bottle Wax Removal Tool, is a hand held device approximately 6½ inches in length designed to easily remove the bee's wax seal found on many domestically produced wine bottles. The Wine Bottle Wax Removal Tool will effectively an quickly remove the wax from the upper neck of the wine bottle and thereby prevent the corkscrew from retaining residual wax from extended cork pulls which may lead to ultimately damaging the high end corkscrew. The other end of the (Dual Purpose) Wine Bottle Wax Removal Tool is a simple bottle opener offering a valuable multi-purpose tool for use in home or food service industry.

As marketing Research progressed it was discovered that some professionals in the restaurant industry had little use for the bottle opener function but still had an intense need for the Wax Removal tool for other reasons than the manufacturers of the high-end cork removal manufacturers. The restaurant industry expressed complaints of wax falling into patrons' glass as well as potential for chipped glass. In fact, some professionals had reported that some they had discontinued the purchasing of some winemakers' product due to the difficulty of removing the wax from the cork. Use of the tool by these professional restaurant employees proved to be an ideal solution for reestablishing relationships with some of the winemakers who's purchases were discontinued due to the difficulty of the wax composition and its removal.

### DRAWINGS OF (DUAL PURPOSE) WINE BOTTLE WAX REMOVAL TOOL (NOT TO SCALE)

Drawing 1: Side view of the tool. Left side indicates “angled” wax removal blade. The Right side view indicates bottle opener end

Drawing 2: Center of drawing indicates bottom side of the tool. The top end of the drawing displays the bottle-opening end while the lower end of the drawing displays the wax removal blade. Circled and offset the left of the main drawing is a representation of a close-up look at the “angled” end of the wax removal blade.

Drawing 3: Represents the top view of the “(Dual Purpose) wax removal tool and bottle opener shown on the top end of the page.

Drawing 4: depicts a typical or proper grip of the hand readying to insert tool into top of wine bottle wax (below hand)

Drawing 5: depicts tool inserted into wax. The arrows indicate the direction the tool is to be turned once inserted into the wax while removing the wax seal. Neither the hand nor the wine bottleneck is to scale (to each other) in order to better illustrate the method of the wax removal tool's technique for removal.

Drawing 6: Illustrates the dual functionality or bottle opening end the Dual Purposed Wine bottle Wax Seal Removal tool and Bottle opener found on the opposite end of the blade end the wax removal tool. As illustrated the “bottle opening end sits firmly on the top of a bottle cap ready to pry upward to remove the bottle cap from the bottle.

Drawing 7: Depicts an optional variation for the home consumer or restaurant industry. This variation depicts a wood grained handle, while others may simply have a rubber grip to prevent slippage while using the tool under wet conditions.

Drawing 8: Depicts Optional (Single Purpose) Wine Bottle Wax Removal Tool and conceptual or potential finished product. Note that use will Duplicate use depicted in Drawings #4 and #5.

1. (canceled)

2. Optional single purpose wine bottle wax seal removal tool or device for the purpose of removing the wax seal, as referenced and in accordance to claim 1, located at the upper most portion of a wine bottle corkage, comprised of a metallic (or other suitable alloy or other sturdy material), linear shaft forming a handle, attached to or fixed to the handle, whereby one end of the linear shaft or handle shall necessarily have a flattened, angular shaped blade whereby said blade will have a slight upward or angular bend (not to exceed a 40 degrees); said angular shaped blade will finish with an angular tip forming the apex of the blade, thereby functioning as insertion point of tool for the purpose of removing or gouging wax seal cleanly from wine bottle cork.
